(19) United States
(12) Patent Application Publication
(10) Pub. No.: US 2002/0112949 A1
(43) Pub. Date: Aug. 22, 2002

(54) Modular clear roof and dark basin solar still

(76) Inventors: Yong Min Cho, Silver Spring, MD (US); Philip Yong Kim, Silver Spring, MD (US)

Correspondence Address: Mr. Yong Min Cho, 16605 Sea Island Court, Silver Spring, MD, 20905, US

(21) Appl. No.: 09/785,279

(22) Filed: Feb. 20, 2001

(51) Int. Cl. B01D 3/02; C02F 1/14

(52) U.S. Cl. 203/10; 203/DIG. 1; 203/DIG. 17; 203/100; 203/86; 159/903; 159/DIG. 15; 202/234; 202/267.1

(57) ABSTRACT

Although water covers three-fourths of the earth's surface, it is unevenly distributed throughout. In some places, the demand for water exceeds the supply. There are several hundred desalination plants in the world, but it is very costly to produce fresh water. The Modular Clear Roof and Dark Basin Solar Still is a low-cost way to produce fresh water. The multiple modular roofs made of glass and/or clear plastic acts like a greenhouse. The sun shines through the roof creating heat. The salt water evaporates and condenses to make fresh water. This fresh water is collected in the half-pipes. Through a gravity flow, this water is collected in a water tank. This is feasible and effective in areas where the demand for water is high, especially in the equatorial or desert area.

### BACKGROUND OF THE INVENTION

Water is everywhere. It covers almost three-fourths of the earth's surface. Water is the most common and important substance on earth. All living things depend on water. But the earth's water supply is not evenly distributed. In some places, the people's demand for water exceeds the supply. People have also polluted their water supplies and have made them unfit to use. Today people have begun to work toward solving this water problem.

People use far more fresh water than the amount they need to stay alive. We use water to wash ourselves, our clothes, and our dishes; to brush our teeth; to cook our food; and in many other ways. Water is essential for growing crops. In some areas the land either does not get enough rain, or it gets rain at the wrong time of year for farming.

Fresh water can be made from salt water. There are several hundred desalination plants in the world. Most of them remove salt and other minerals from water through a process called distillation. In this process, the water is heated to produce water vapor. As the water changes to gas, it leaves the minerals behind. Then the vapor is cooled, forming fresh water. Most desalination plants use fuels to heat water in large tanks, which can be costly.

One of the simplest ways to distill water is in a solar still. The top of the still has a glass roof, like a greenhouse. The sun shines through the roof onto a shallow pool of salt water, which is in a basin. The water heats up, and it evaporates, leaving the salt behind. The rising vapor condenses on the underside of the glass, forming drops of fresh water that run down into collecting channels, the half-pipes. The water from the half-pipes is collected in lower level water tanks or pools.

### SUMMARY OF THE INVENTION

The top of the system has a glass or clear plastic modular roof and dark modular basin. The roof works similarly like a greenhouse. The sun shines through the roof and keeps the heat in the system. The salt water is in a shallow basin underneath the roof. The water evaporates and condenses when it reaches the roof. The condensed water is now fresh. The fresh water collects in the multiple half-pipes. The whole system is on a slight tilt. This will allow for a gravity flow to push the water down the half-pipes. The water from the half-pipes would then collect in a lower level water tank or pool.

### BRIEF DESCRIPTION OF THE DRAWING

This invention can be fully understood through references to the following four figures and their brief descriptions below:

FIG. 1 is a side view of the modular clear roof and dark basin solar still system.

FIG. 2 is a conceptual view of the modular roof

FIG. 3 is a conceptual view of connected multiple modular roofs.

FIG. 4 is an aerial view of the connected multiple modular basin.

### DETAILED DESCRIPTION OF THE DRAWING

In FIG. 1, the modular clear roof 1 is sitting on the dark basin 2. The modular clear roof 1 has multiple half-pipe 3 to collect the fresh water 4 from evaporation of the salt water 5. The bottom of the basin 6 is covered by a dark color.

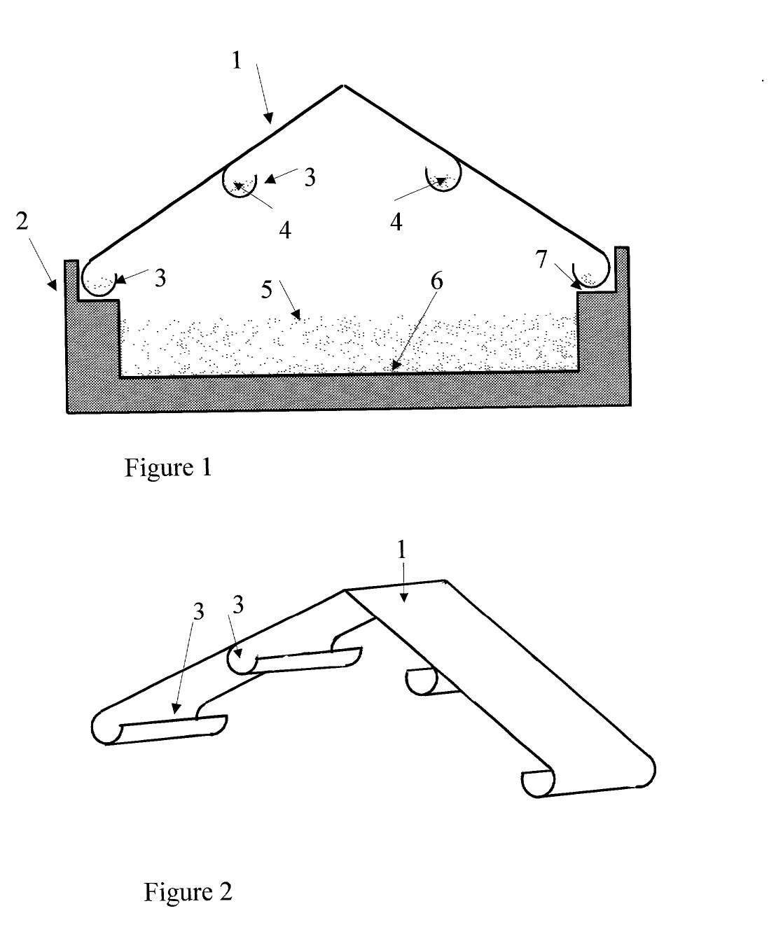

In FIG. 2, the modular clear roof 1 has multiple clear half-pipes 3.

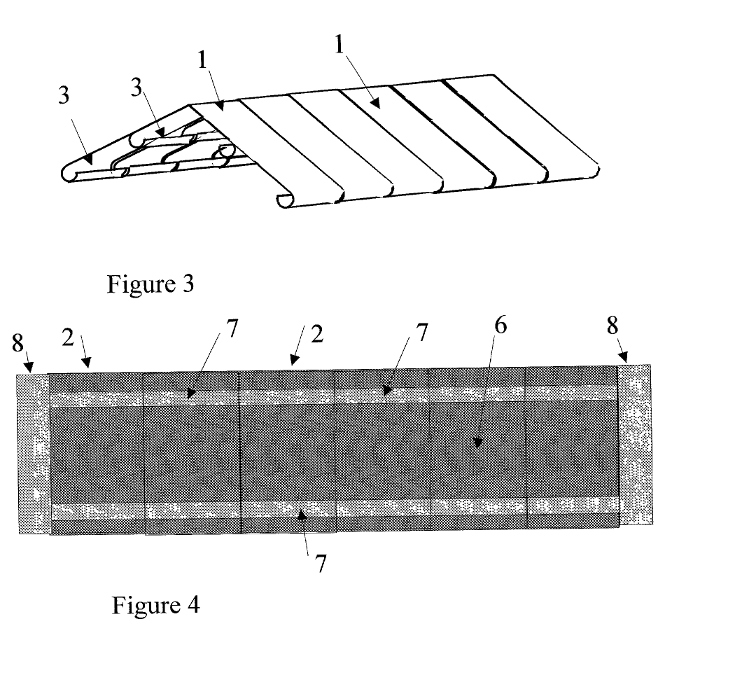

In FIG. 3, the half-pipes 3 of the modular clear roofs 1 will be connected to collect the fresh water flow.

In FIG. 4, the modular dark basins 2 are connected to contain salt water. The modular clear roof 1 will sit on the shoulder 7 of the dark basin 2. Both ends of the long connected basins have flat end unit wall 8 to contain the salt water.

I claim:

1. The multiple modular roofs, which can be connected, made of glass and/or clear plastic, which has the multiple pre-installed clear half-pipes.

2. The rectangular-shaped modular basin which holds the salt water underneath the modular roof.
